(19) United States
(12) Patent Application Publication
(10) Pub. No.: US 2005/0103110 A1
(43) Pub. Date: May 19, 2005

(54) Integrated pressure and temperature sensor

(75) Inventors: Craig Ernsberger, Granger, IN (US); Jason Langhorn, South Bend, IN (US); James Patrick McKenna, Edinburgh (GB)

Correspondence Address: CTS CORPORATION, 905 W. BLVD. N, ELKHART, IN, 46514, US

(73) Assignee: CTS Corporation

(21) Appl. No.: 11/008,553

(22) Filed: Dec. 9, 2004

Related U.S. Application Data
(63) Continuation-in-part of application No. 10/931,134, filed on Aug. 31, 2004.
Application No. 10/931,134 is a continuation-in-part of application No. 10/846,759, filed on May 14, 2004.
Application No. 10/846,759 is a continuation-in-part of application No. 10/716,752, filed on Nov. 19, 2003.

(51) Int. Cl. G01L 7/00

(52) U.S. Cl. 73/708

(57) ABSTRACT

A temperature and pressure sensor for sensing the temperature and pressure of a media and providing electrical signals that are indicative of the temperature and pressure level of the media. The sensor includes a housing that has a high pressure side, a low pressure side and an aperture. A substrate is located in the aperture. The substrate has a pair of ends and a center portion. The center portion is affixed to the housing. The center portion seals the high pressure side from the low pressure side. A pressure sensitive resistor and a thermistor are mounted on one end of the substrate and a reference resistor is mounted on the other end of the substrate.

### CROSS REFERENCE TO RELATED AND CO-PENDING APPLICATIONS

This application is a continuation in part of U.S. patent application Ser. No. 10/931,134, filed Aug. 31, 2004 and entitled, “Pressure Sensor”, which is a continuation in part of U.S. patent application Ser. No. 10/846,759, filed May 14, 2004 and entitled, “Pressure Sensor”, which is a continuation in part of U.S. patent application Ser. No. 10/716,752, filed Nov. 19, 2003 and entitled, “Pressure Sensor”. The entire contents of both of these applications are herein expressly incorporated by reference.

### BACKGROUND

The present invention relates to sensors in general and in particular to a pressure and temperature sensor.

Conventional devices for high pressure measurement of a pressurized medium in severe environments rely on a diaphragm in conjunction with a pressure sensing element. Various pressure sensing elements have been used such as strain gages, piezoresistive devices and semiconductor based sensing elements. These devices are constructed such that the diaphragm is positioned between the pressurized process media and the pressure sensing element. The diaphragms are subject to mechanical fatigue and therefore limit the service life of conventional high pressure sensors. A diaphragm free high pressure sensor is therefore desirable.

In some applications, it is also useful to measure the temperature of the pressurized medium. A separate temperature sensor can be used. However, in some applications, space for a separate temperature sensor may not be available. In addition, the use of a separate sensor requires additional parts, connectors and calibration.

Present common rail fuel injection systems employ separate pressure and temperature sensors. The temperature sensor is located on the low pressure side of the system while the pressure sensor is located on the high pressure rail. There are two primary drivers to integrate the temperature and pressure sensors. First, packaging costs represent a substantial portion of both pressure and temperature sensor costs. By combining both sensors in one package, a cost savings can be passed along to the customer. Secondly, by moving the temperature sensor to the fuel rail, a much more meaningful temperature measurement of the fuel can be obtained.

A current unmet need exists for a combined pressure and temperature sensor.

### SUMMARY OF THE INVENTION

It is a feature of the present invention to provide a temperature and pressure sensor for sensing the temperature and pressure of a media and providing electrical signals that are indicative of the temperature and pressure level.

It is a feature of the present invention to provide a pressure and temperature sensor for attachment to a pressure vessel that includes a housing that has a high pressure side, a low pressure side and an aperture. A substrate is located in the aperture. The substrate has a pair of ends and a center portion. The center portion is affixed to the housing. The center portion seals the high pressure side from the low pressure side. A pressure sensitive resistor is mounted on one end and a reference resistor is mounted on the other end. A thermistor is mounted on the other end. A pair of circuit lines are located on the substrate and connected with the pressure sensitive resistor, the reference resistor and the thermistor.

### BRIEF DESCRIPTION OF THE DRAWINGS

FIG. 1 is a perspective view of a pressure sensor.

FIG. 2 is an exploded view of the pressure sensor of FIG. 1.

FIG. 3 is a cross-sectional view of the pressure sensor of FIG. 1.

FIG. 4 is another cross-sectional view of the pressure sensor of FIG. 1.

FIG. 5 is an enlarged view of a portion of FIG. 4 showing details of the substrate attachment to the housing.

FIG. 6 is a perspective view of an LTCC substrate.

FIG. 7 is an exploded view of FIG. 6.

FIG. 8 is a top view of a printed circuit board.

FIG. 9 is a cross-sectional view of an alternative embodiment of a pressure sensor housing.

FIG. 10 is a perspective view of an alternative embodiment of an alumina substrate.

FIG. 11 is a cross-sectional view of FIG. 10 taken along section line A-A in FIG.13.

FIG. 12 is a right side view of FIG. 10 without the center dielectric and metal.

FIG. 13 is a top view of FIG. 10 without the center dielectric and metal.

FIG. 14 is a left side view of FIG. 10 without the center dielectric and metal.

FIG. 15 is a bottom view of FIG. 10 without the center dielectric and metal.

FIG. 16 is a cross-sectional view of yet another alternative embodiment of a pressure sensor housing.

FIG. 17 is a perspective view of a glass pre-form.

FIG. 18 is a perspective view of yet another alternative embodiment of an alumina substrate.

FIG. 19 is a top view of a substrate with a thermistor that is used to make an integrated pressure and temperature sensor.

FIG. 20 is a top view of an alternative substrate with a thermistor.

FIG. 21 is a cross-sectional view of an alternate embodiment of an integrated pressure and temperature sensor housing.

FIG. 22 is a graph of resistance versus temperature for various pressure levels.

It is noted that the drawings of the invention are not to scale. In the drawings, like numbering represents like elements among the drawings.

### DETAILED DESCRIPTION

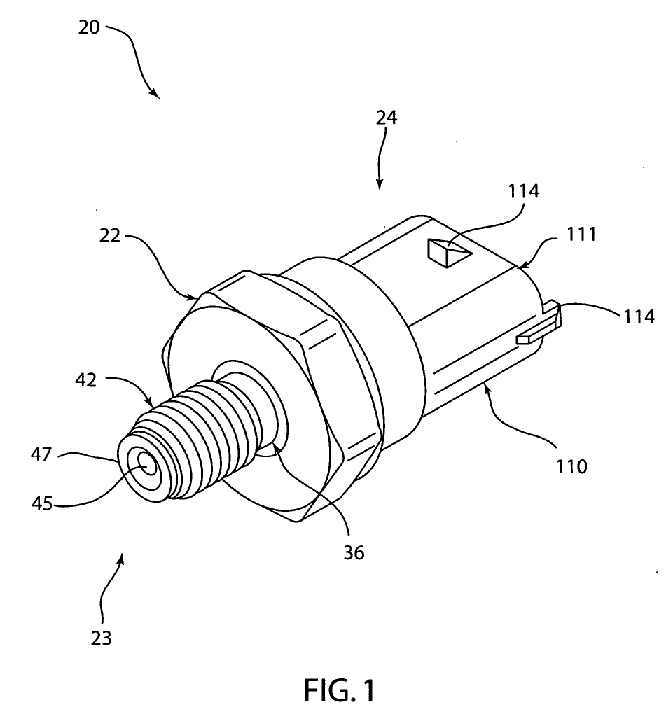

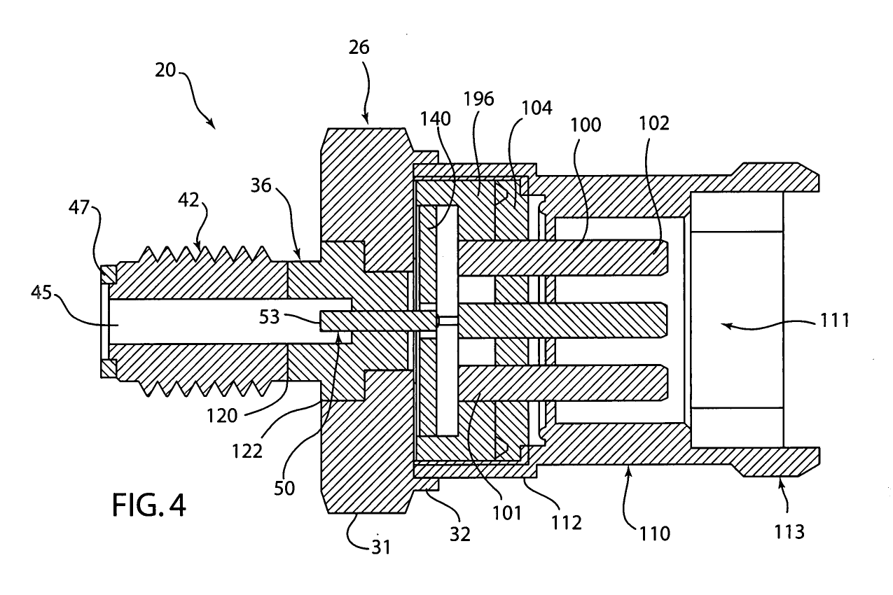

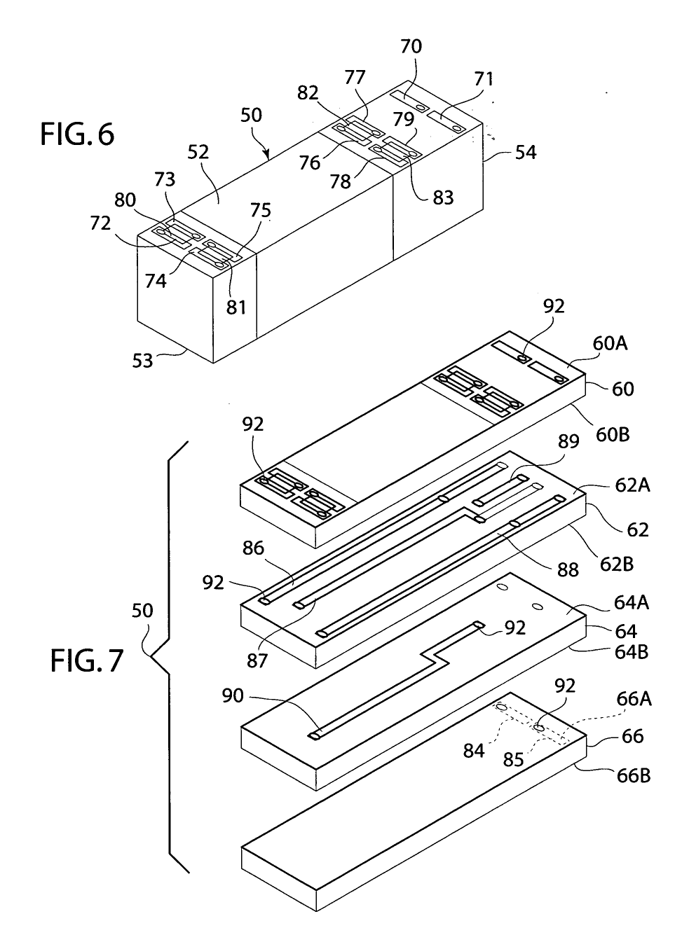

Referring to FIGS. 1-8, an embodiment of a pressure sensor assembly 20 is shown. Pressure sensor assembly 20 has a housing 22. Housing 22 has a high pressure side 23 and a low pressure side 24. Housing 22 has several parts. Housing 22 has a hexagonal shaped portion/housing 26, an insert 36, an exteriorly threaded generally cylindrically-shaped portion/member 42 and a connector 110. Hexagonal shaped portion 26 has sides 27 and 28. Several flat surfaces 31 are placed on the outside of portion 26 so that a wrench can rotate the sensor. An aperture 29 extends through the center of portion 26. A step 30 resides in flange 32. Flange 32 extends from side 27. Portion 26 can be made out of a metal such as stainless steel.

An insert 36 has an inner wall 34, a rim 37, ends 38 and 39 and a bore 45 extending through the insert. The insert 36 fits into aperture 29 with rim 37 resting on step 30. Insert 36 can be made out of a metal such as stainless steel. Insert 36 is laser welded to portion 26 by a weld 122.

An exteriorly threaded portion 42 is attached to insert 36. Threaded portion 42 has ends 43 and 44 and a bore 45 extending through threaded portion 42. The threads are used to attach the pressure sensor to a pressure vessel (not shown). Threaded portion 42 can be made out of a metal such as stainless steel. Threaded portion 42 is attached to insert 36 by weld 120. A seal ring 47 is attached to end 44. Seal ring 47 is used to seal the pressure sensor to a pressure vessel.

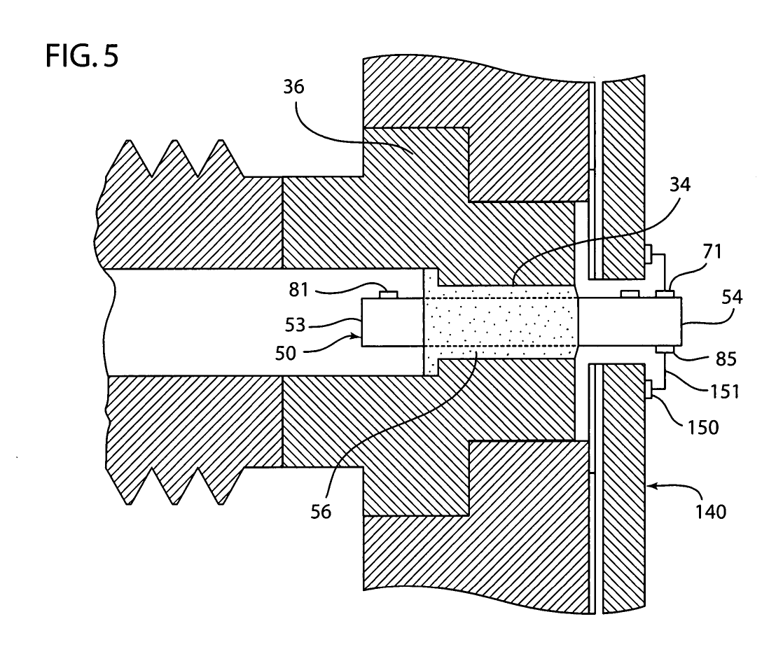

An elongated block shaped substrate 50 is located inside of bore 45 within insert 36. Substrate 50 has a center section 52 and ends 53 and 54. Center section 52 is coated with a metal such as nickel plated silver. Typically, the silver would be applied by a screening process and then electroplated with nickel. Center section 52 is brazed into bore 45 using a braze alloy 56 (FIG. 5) of approximately 60% copper, 30% silver, and 10% tin. The braze alloy 56 is commercially available from Lucas Milhaupt Corporation of Cudahay, Wis. The alloy is placed in the form of a pre-form and then heated to 760 degrees centigrade in a nitrogen reflow furnace. During reflow, the braze alloy wicks along the length of center section 52. The braze alloy fills the space between center section 52 and wall 34. Braze alloy 56 creates a hermetic seal between the high pressure side 23 and low pressure side 24.

Substrate 50 can be an alumina ceramic, a low temperature co-fired ceramic, glass or a metal with an applied dielectric surface. Preferably, substrate 50 is a low temperature co-fired ceramic (LTCC). Substrate 50 has a top surface 60A and a bottom surface 66B (FIG. 7). Substrate 50 is comprised of multiple layers of low temperature co-fired ceramic material. Planar layers 60, 62, 64 and 66 are all stacked on top of each other and form a unitary structure 50 after firing in an oven. LTCC layers 60-66 are commercially available in the form of a green unfired tape from Dupont Corporation. Each of the layers has a top surface 60A, 62A, 64A and 66A respectively. Similarly, each of the layers has a bottom surface 60B, 62B, 64B and 66B respectively.

The layers have several circuit features that are patterned on the surfaces. Layer 60 has several circuit features that are patterned on surface 60A. Surface 60A has two terminals 70 and 71 and eight conductor pads 72, 73, 74, 75, 76, 77, 78 and 79. Four resistors 80, 81, 82 and 83 are located on surface 60A. Each resistor is electrically connected between two conductor pads. Resistors 80 and 81 are pressure sensitive resistors. Resistors 82 and 83 are also pressure sensitive resistors. Resistors 82 and 83 have a constant value as they are not exposed to the pressurized medium.

The terminals and conductor pads are formed from an electrically conductive and solderable material. The pressure sensitive resistors 80 and 81 are exposed to the pressurized medium. Resistors 80 and 81 can be conventional thick film resistors that are manufactured using conventional thick film processing techniques. A preferred resistor composition is Heraeus 8241 resistor material, which is commercially available from Heraeus Corporation of West Conshohocken, Pa.

Further information on the manufacture and processing of resistors 80 and 81 can be found in U.S. patent application Ser. No. 10/716,752, the contents of which are herein incorporated by reference in its entirety.

Layer 62 has conductor lines 86, 87, 88 and 89 located on surface 62A. Layer 64 has conductor line 90 located on surface 64A. The conductor lines are buried within substrate 50. The conductor lines are electrically connected to the conductor pads and terminals by vias 92. Vias 92 are formed from an electrically conductive material and electrically connect one layer to another layer. Layer 66 has two terminals 84 and 85 located on surface 66B.

The circuit features and vias of substrate 50 are formed by screen printing conventional thick film conductor and via materials on the low temperature ceramic layers. The layers are then stacked onto each other and fired in an oven to produce a unitary part.

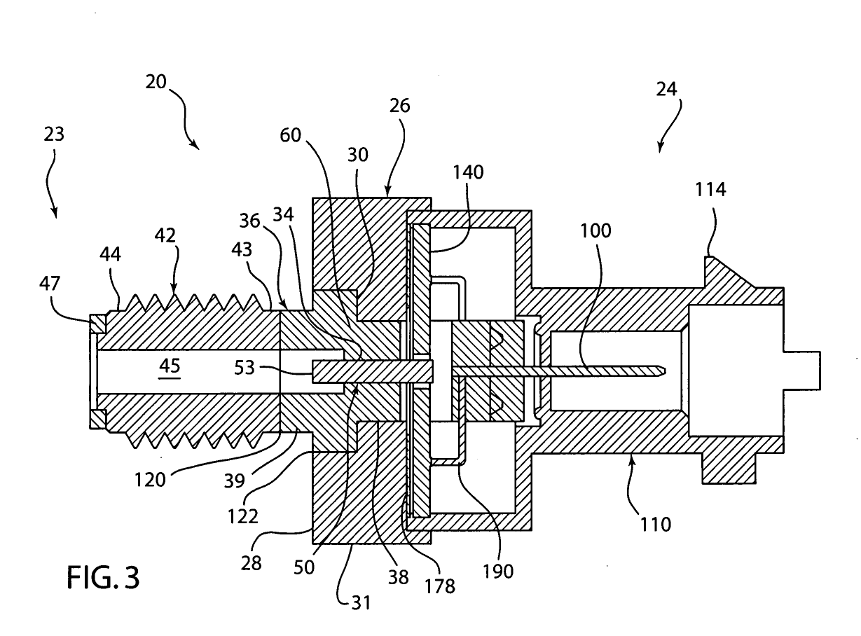

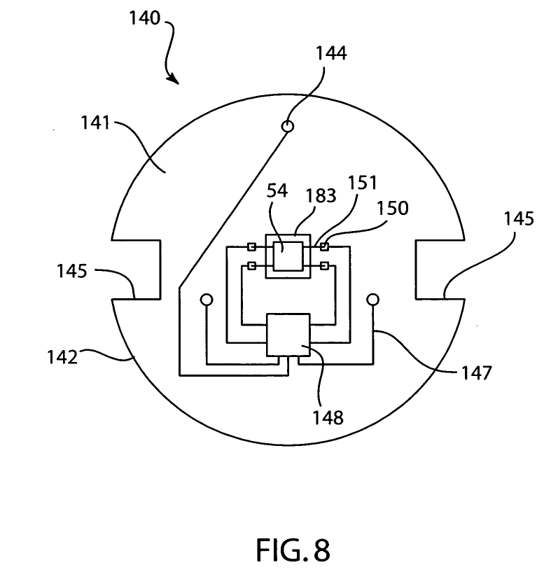

Substrate 50 extends through aperture 29 of hexagonal portion 26 and into the central aperture 183 (FIG. 8) of printed circuit board 140 (FIG. 3). An adhesive disk 178 is sticky on both sides and holds printed circuit board 140 to hexagonal housing side 27.Printed circuit board 140 has a top side 141, bottom side 142, terminal holes 144, notches 145, terminals 150 and hole 183 (FIG. 8). An integrated circuit 148 is mounted to top side 141. Integrated circuit 148 is used to condition and amplify an electrical signal coming from the pressure sensitive resistors 80 and 81. Integrated circuit 148 can also contain circuitry for calibration and temperature compensation.

Circuit lines 147 are connected between integrated circuit 148, terminal holes 144 and terminals 150. Four metal leads or wires 151 are soldered between terminals 150 on the printed circuit board and terminals 70, 71, 84 and 85 on substrate 50.

Resistors 80, 81, 82 and 83 are connected to form a Wheatstone bridge. In the Wheatstone bridge, resistors 80 and 81 are called the sense resistors and resistors 82 and 83 are called the reference resistors. Resistors 80 and 81 change resistance in response to pressure changes. Resistors 82 and 83 have a relatively constant value as they are not exposed to changes in pressure.

A voltage is applied across the Wheatstone bridge and the voltage change across the bridge is monitored. The pressure level is proportional to the bridge voltage, which changes as the resistance of resistors 80 and 81 change.

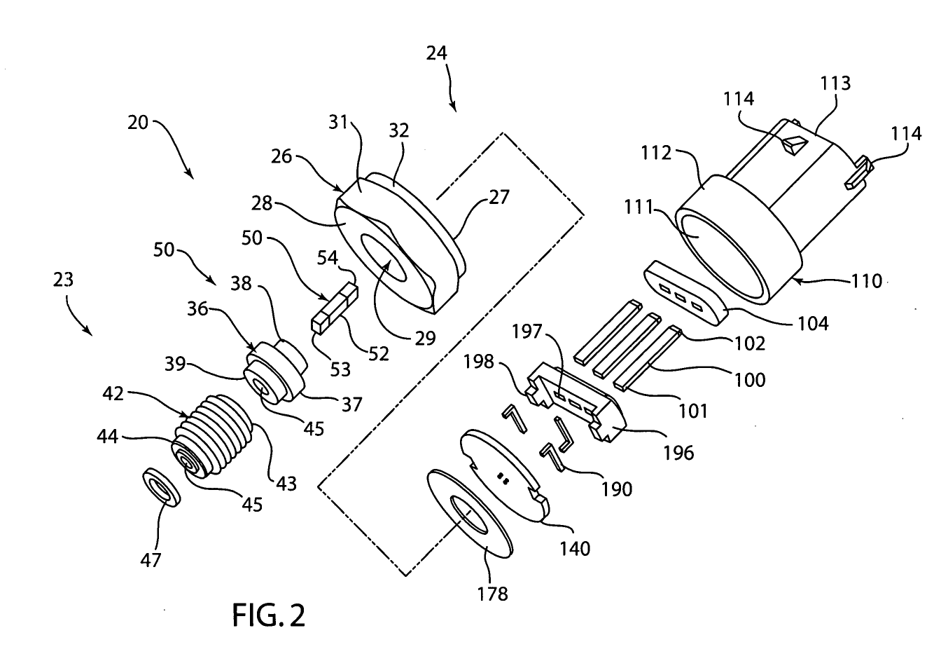

Three transfer terminals 190 are held by terminal carrier 196 (FIG. 2). Terminal carrier 196 has through-holes 197 and posts 198. Terminal carrier 196 is mounted over printed circuit board 140. Posts 198 fit into the respective opposed notches 145 defined in the periphery of board 140. Transfer terminals 190 have one end soldered into board terminal holes 144.

Elongate connector terminals 100 are mounted into respective holes 197. Connector terminals 100 have ends 101 and 102. Connector terminal ends 101 are in electrical contact with transfer terminal 190. Connector terminals 100 supply a voltage to the resistors and allow an output signal to be transmitted from the pressure sensor.

A hollow connector 110 is mounted over terminals 100, terminal carrier 196 and printed circuit board 140 (FIG. 2). Connector 110 protects the terminals and printed circuit board 140. Connector 110 can be a molded plastic material. Connector 110 has an interior cavity 111, ends 112,113 and latch tabs 114 located at end 113. End 112 fits into flange 32 of hexagonal portion 26. A generally oval-shaped seal 104 is located between terminal carrier 196 and connector 110. Seal 104 prevents contamination from outside the connector from entering the area of the printed circuit board. Latch tabs 114 are designed to retain an external wiring harness (not shown). The wiring harness would mate with terminals 100 and would connect to another external electronic circuit (not shown).

Resistors 80 and 81 change resistance in response to the applied pressure level. The resistance across the resistors is about 410 ohms when the pressurized medium is pressurized to 5000 pounds per square inch. The resistance across the resistors is about 360 ohms when the pressure is 50,000 pounds per square inch. The resistance value is linear with pressure.

Pressure sensor 20 is most useful for measuring large changes in pressure and for use with high pressures. This is due to the fact that the resistance change with pressure is small over a large pressure range. Pressure sensor 20 is best used with pressure ranges above 500 pounds per square inch. Pressure sensor 20 can be used to detect pressures down to 0 pounds per square inch (gauge pressure).

Assembly

Pressure sensor 20 can be assembled in the following sequence:
1. Substrate 50 is placed in bore 45 of housing insert 36 adjacent to wall 34.
2. A braze alloy 56 preform is placed adjacent to center portion 52.
3. The substrate 50, braze alloy 56 and housing 36 are placed in an oven at 760 degree Centigrade where the braze alloy wicks along the length of the center section 52 forming a hermetic seal.
4. Insert 36 is placed into aperture 29 of hexagonal housing 26 and laser welded in place with weld 122.
5. End 43 of threaded portion 42 is placed into abutting relationship with the end 39 of insert 36 and laser welded in place with weld 120.
6. Seal ring 47 is attached to end 44 of the threaded portion 42.
7. Adhesive disc 178 is positioned against the side 27 of hexagonal housing 26.
8. Circuit board 140 is mounted against the surface of adhesive disk 178 with substrate end 54 extending through the central aperture 183 defined in board 140.
9. Metal leads 151 on board 140 are soldered between terminals 150 and terminals 70, 71, 84 and 85.
10. Transfer terminals 190 are soldered into the apertures 144 defined in the face of board 140.
11. Terminals 100 are inserted into the respective through apertures 197 defined in the body of terminal carrier 196.
12. Terminal carrier 196 is placed against the top side 141 of circuit board 140 with posts 198 engaged in respective board notches 145 and terminals 100 are positioned in contact with transfer terminals 190.
13. Seal 104 is slid over the ends of respective terminals 100.
14. Connector shroud 110 is placed over terminals 100 with end 112 press fitted against the flange 32 of hexagonal portion 26.

### SECOND EMBODIMENT

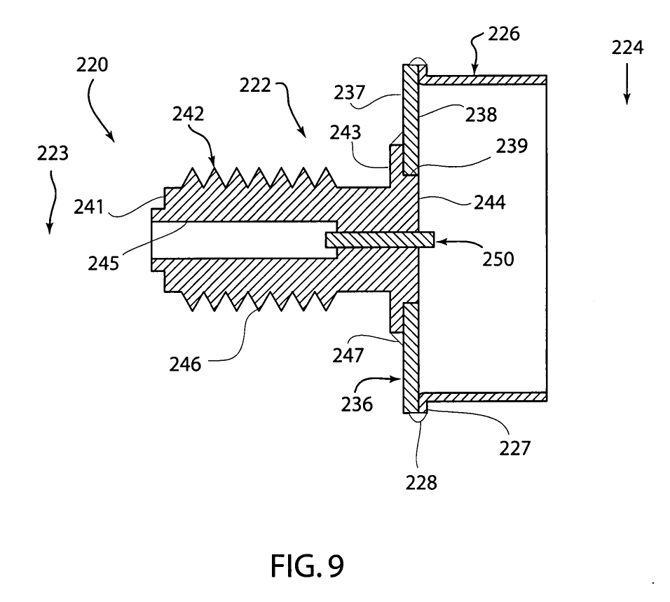

Turning to FIG. 9, a cross-sectional view of an alternative embodiment of a pressure sensor 220 is shown. Housing 222 has a high pressure side 223 and a low pressure side 224. Housing 222 has several parts. Housing 222 has a hexagonal-shaped portion/member 226, a washer 236 and an exteriorly threaded generally cylindrically-shaped portion/member 242. For simplicity, the connector portion and printed circuit board are not shown. Hexagonal-shaped portion 226 has a peripheral lip 227 defined at one end that is welded to washer 236 by a weld 228. Housing 222 can be made out of a metal such as stainless steel.

Washer 236 has surfaces 237 and 238 and a center through-hole 239. Threaded portion 242 has ends 241, 244, a peripheral rim 243, a bore 245 and exterior threads 246. End 244 fits into hole 239 with the outside face of rim 243 abutted against the surface 237 of washer 236. Rim 243 is laser welded to the surface 237 of washer 236 by a weld 247. The threads 246 are used to attach the pressure sensor housing to a pressure vessel (not shown). Substrate 250 can be sealed into bore 245. The remainder of the pressure sensor assembly would be the same as for the previously described pressure sensor 20.

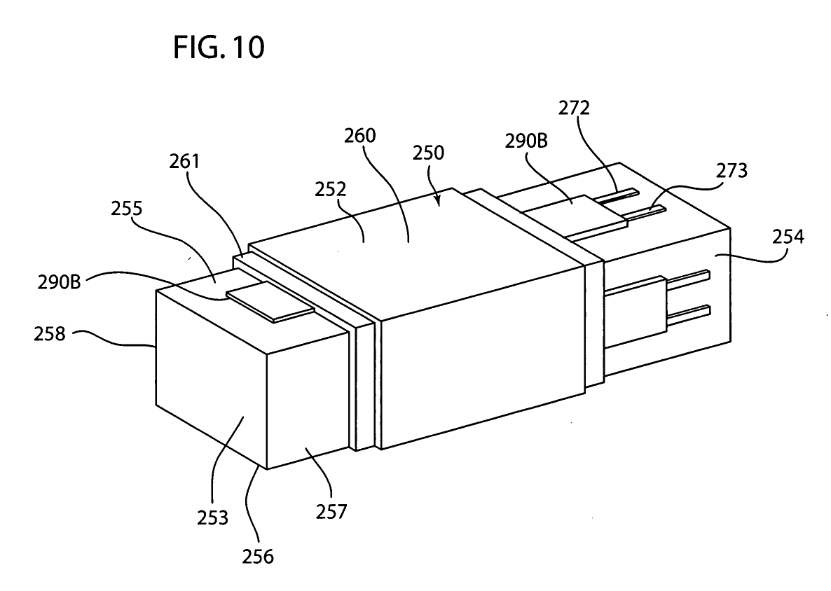

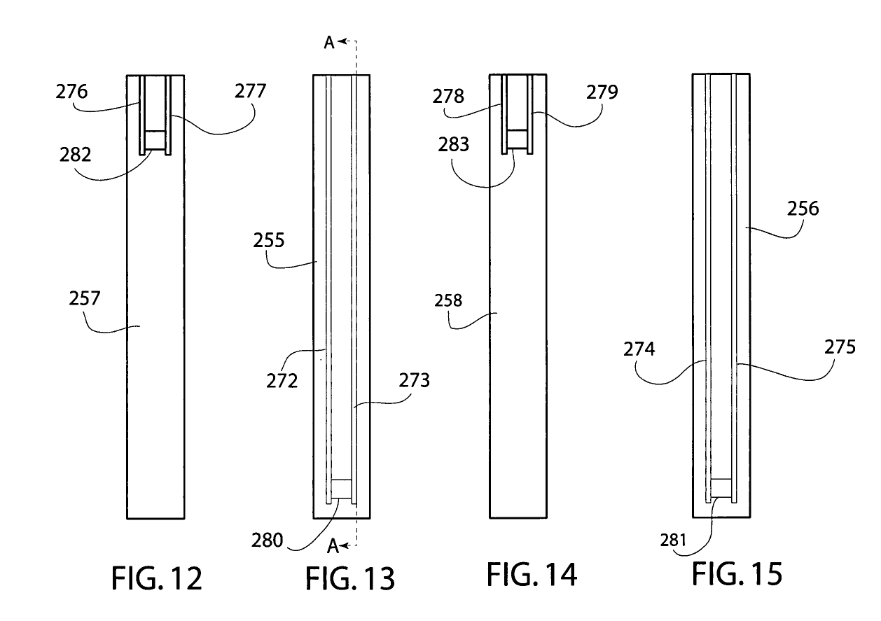

Referring now to FIGS. 10-15, a perspective view of an alternative embodiment of an alumina substrate is shown. In FIGS. 12-15, the center dielectric and metal material are removed to show details of the resistors and conductors. An elongated block shaped substrate 250 has a center section 252, ends 253 and 254, top surface 255, bottom surface 256, and side surfaces 257 and 258. Center section 252 is coated with a metal 260 such as nickel plating over a thick film conductor 261 such as silver. The thick film conductor would be applied by a screening process and then electroplated with nickel. Center section 252 is brazed into either of the bores 45 or 245 of threaded members 42 and 242 respectively in the same manner as described above for pressure sensor 20. The braze alloy is approximately 60% copper, 30% silver, and 10% tin. The braze alloy creates a hermetic seal between the high pressure side and low pressure side of the housing.

Substrate 250 is formed from high temperature alumina ceramic. Several circuit features are patterned on the surfaces of substrate 250. Top surface 255 has a pressure sensitive resistor 280 and two conductor lines 272 and 273. Bottom surface 256 has a pressure sensitive resistor 281 and two conductor lines 274 and 275. Side surface 257 has a resistor 282 and two conductor lines 276 and 277. Side surface 258 has a resistor 283 and two conductor lines 278 and 279. Each resistor is electrically connected between two conductor lines.

The conductor lines are formed from an electrically conductive and solderable material. The pressure sensitive resistors 280 and 281 are exposed to the pressurized medium. The resistors and circuit lines can be conventional thick film resistors and conductors that are manufactured using the same techniques as described above for substrate 50.

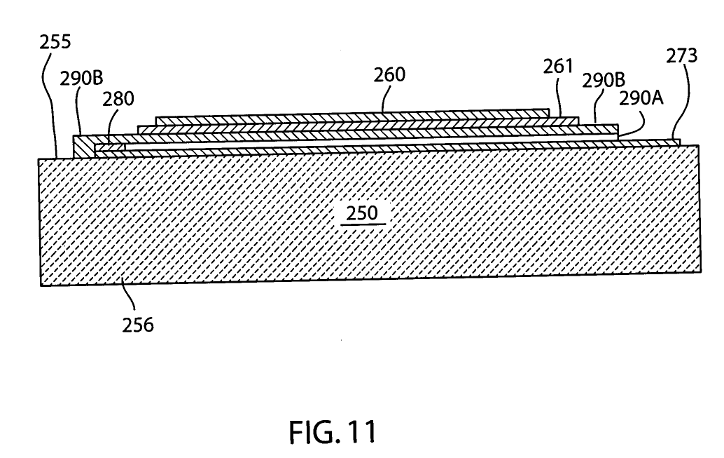

A dielectric material 290 (FIG. 10 and 11) covers the circuit lines in center section 252. Dielectric material 290 has two sections or layers 290A and 290B that are deposited over the circuit lines in separate steps. Thick film conductor 261 is screen printed over dielectric 290B and then electroplated with nickel 260.

### THIRD EMBODIMENT

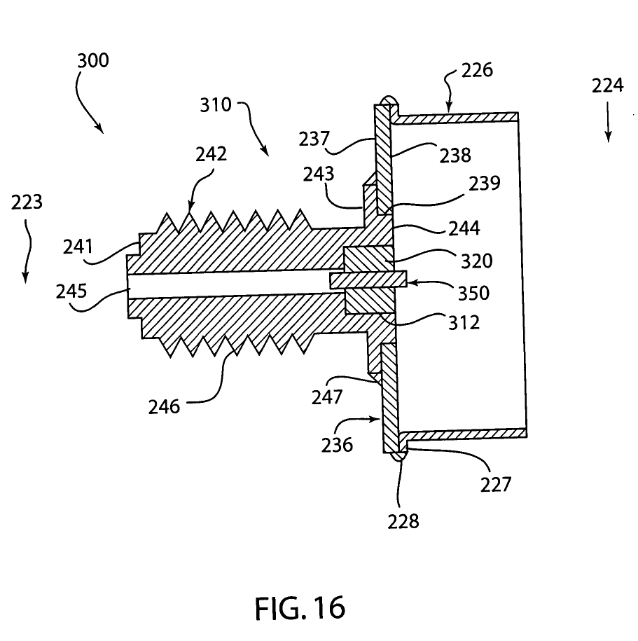

Turning to FIGS. 16-18, a cross-sectional view of another embodiment of a pressure sensor 300 is shown. Housing 310 has a high pressure side 223 and a low pressure side 224. Housing 310 has several parts. Housing 310 has a hexagonal-shaped portion/member 226, a washer 236 and a threaded portion/member 242. For simplicity, the connector portion and printed circuit board are not shown. Hexagonal-shaped portion 226 has a peripheral lip 227 defined at one end that is welded to washer 236 by a weld 228. Housing 310 can be made out of a metal such as stainless steel.

Washer 236 has surfaces 237 and 238 and a center through hole 239. Exteriorly threaded member 242 has ends 241, 244, a rim 243 located in the region of the end 244, an interior central bore 245 defined therethrough, exterior threads 246 and an interior cavity 312 which extends centrally into the end 242 and terminates into bore 245. Cavity 312 has a diameter greater than the bore 245. End 244 of washer 236 is fitted into the hole 239 with rim 243 resting on surface 237. Portion 242 is laser welded to washer portion 236 by a weld 247. The threads are used to attach the pressure sensor housing to a pressure vessel (not shown).

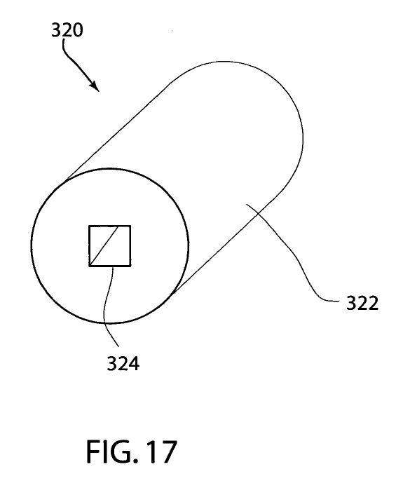

A generally cylindrically-shaped glass pre-form 320 is mounted in cavity 312 in a relationship wherein the end thereof is flush with the end face 242 of threaded member 242. Glass pre-form 320 has an outer surface 322 and a generally square-shaped central through bore or hole 324 (FIG. 17). Substrate 350 extends through the bore 324.

Glass pre-form 320 forms a glass to ceramic seal between threaded portion 242 and substrate 350. During manufacturing, substrate 350 would be placed into bore 324 and then glass pre-form 320 placed into cavity 312. The preform, substrate and threaded portion 242 are then placed in an oven where the glass is sintered to the threaded portion and the substrate forming a hermetic seal.

The remainder of the pressure sensor assembly would be the same as for the previously described pressure sensor 20.

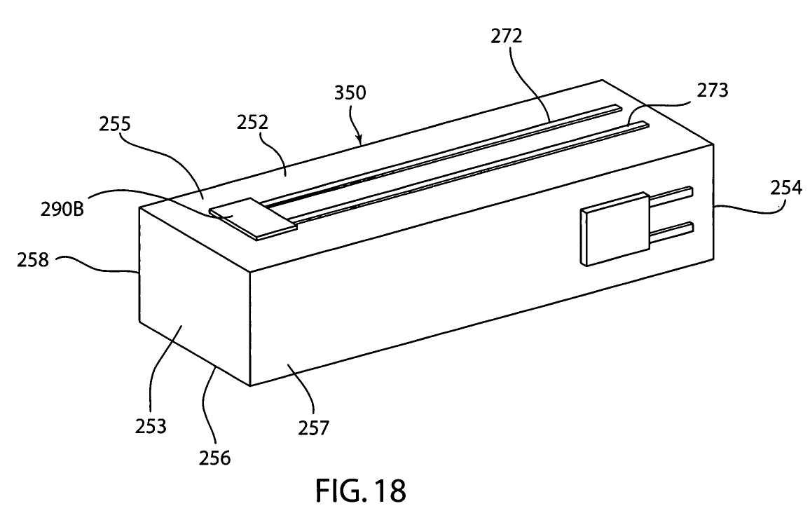

Alumina substrate 350 is the same as substrate 250 of FIG. 10 except that the dielectric, silver thick film and nickel plating in center section 252 are removed. The dielectric material 290B in FIG. 18 only covers the resistors.

### First Integrated Temperature and Pressure Sensor Embodiment

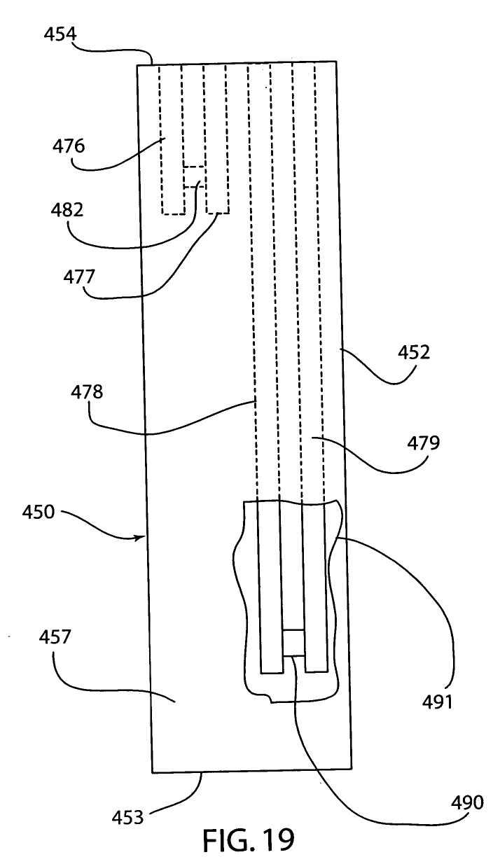

Turning to FIG. 19, a top view of a substrate 450 with a thermistor is shown. Substrate 450 is similar to substrates 250 and 350. Substrate 450 is a rectangular block of high temperature alumina ceramic with four side surfaces, two ends 453 and 454 and a center section 452. Only one side 457 is shown. The other sides would contain the pressure sensitive resistors and the other reference resistors. Substrate 450 has a side 457 that has a reference resistor 482 sandwiched and connected between the ends of two conductor lines 476 and 477. Side 457 also has a thermistor 490 sandwiched and connected between the ends of two conductor lines 478 and 479. Thermistor 490 is covered by an overglaze layer 491.

Thermistor 490 has the property of changing resistance in response to a change in temperature. When a voltage is placed across thermistor 490, a voltage drop occurs across the resistor. If the temperature of thermistor 490 is changed, this voltage drop also changes. The voltage is proportional to the temperature of the pressurized medium and is insensitive to the pressure of the medium.

Thermistor 490 is formed by screen printing a thermistor paste material onto side 457 and firing in an oven. Thermistor 490 can be formed from a negative temperature coefficient thick film material whose resistance varies with temperature, but not pressure. Thermistor 490 can be formed from one of several thermistor compositions that are commercially available from Dupont, Heraeus and Koartan Corporation. The thermistor 490 is overcoated with a passivation or overglaze layer 491. The overglaze layer 491 is commercially available Hereaus 9117D from the Hereaus Corporation of West Conshohocken, Pa. In order to more clearly see thermistor 490, a portion of the overglaze layer 491 is removed in FIG. 19. It is understood that in actuality overglaze layer 491 completely covers thermistor 490 and conductor lines 478 and 479.

Although not shown in FIG. 19, it is understood that center section 452 can be coated with a metal such as nickel plating over a thick film conductor such as silver as shown in FIG. 10 and then brazed into bore 45. Alternatively, center section 452 can be left un-coated and used with a glass pre-form as shown in FIG. 16. Substrate 450 would be connected to a printed circuit board with an electronic circuit in the same manner as shown in FIG. 8. The printed circuit board would contain additional circuitry and wiring to handle the electrical signal from thermistor 490. The electronic circuit would amplify and condition the electrical signal coming from thermistor 490 as is well known in the art.

After mounting in either of the housings 222 or 310 as described above, substrate 450 forms an integrated pressure and temperature sensor that can measure both the pressure and temperature of a pressurized medium.

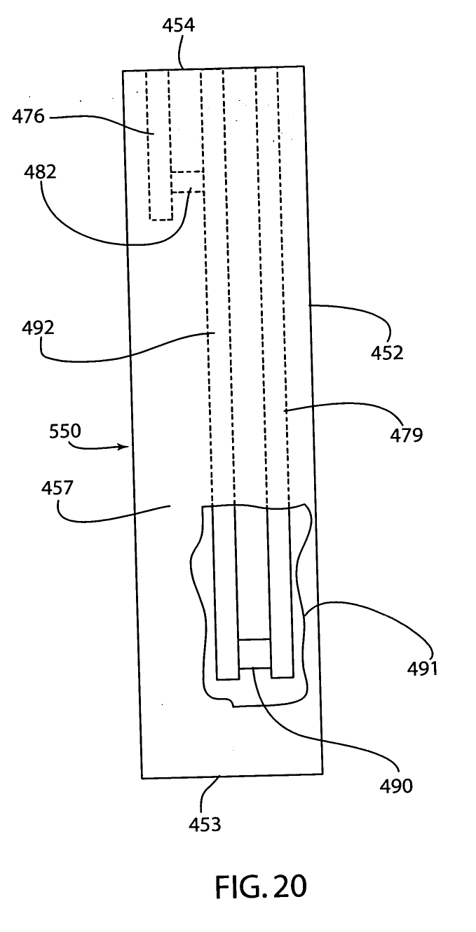

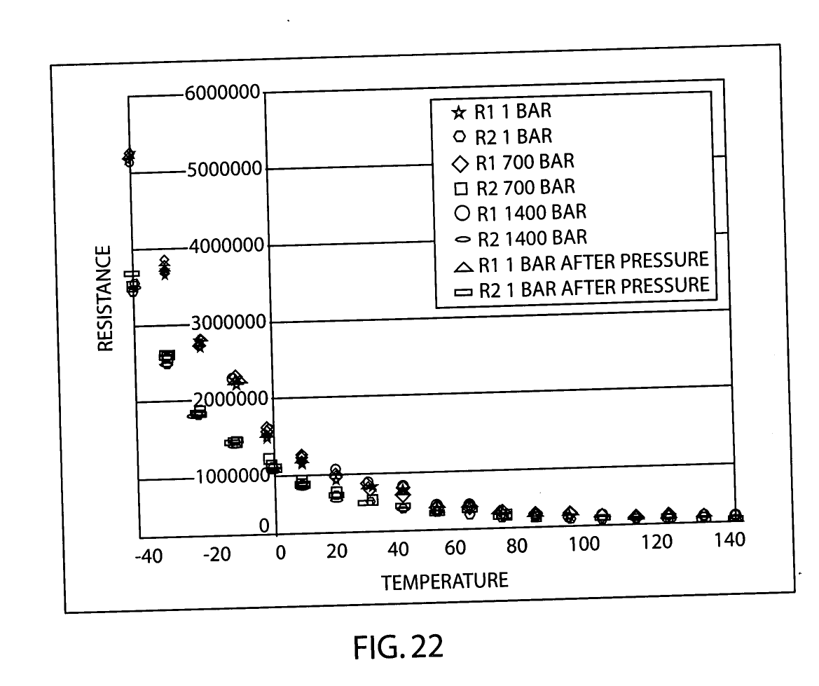

Turning to FIG. 20, another substrate 550 with a thermistor is shown. Substrate 550 is similar in structure to substrate 450 except that substrate 550 uses a common return conductor line 492 between reference resistor 482 and thermistor 490. Substrate 550 would be mounted in either of the respective housings 222 or 310 as described above to form an integrated pressure and temperature sensor. In order to more clearly see thermistor 490, a portion of the overglaze layer 491 is removed in FIG. 20. It is understood that in actuality overglaze layer 491 completely covers thermistor 490 and conductor lines 492 and 479. Several substrates 450 with thermistors 490 were built and tested over temperature and pressure. As can be seen in FIG. 22, the resistance of the sensor is not a function of pressure. In other words, thermistor 490 was insensitive to pressure changes but not temperature.

### Second Integrated Temperature and Pressure Sensor Embodiment

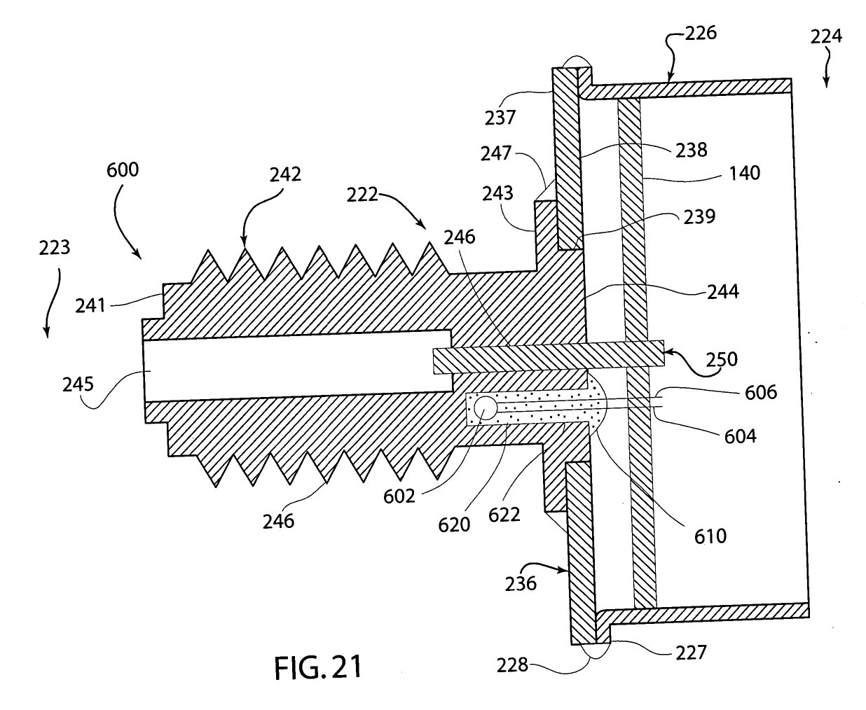

Referring to FIG. 21, a cross-sectional view of an alternate embodiment of an integrated pressure and temperature sensor 600 is shown. Sensor 600 is similar to sensor 220 except that an off-center bore 620 and a bead type thermistor 602 have been added. Housing 222 has a high pressure side or end 223 and a low pressure side or end 224. Housing 222 has several parts. Housing 222 has a hexagonal-shaped portion/member 226, a washer 236 and a threaded portion/member 242.

Washer 236 has surfaces 237 and 238 and a center through-hole 239. Threaded portion 242 has ends 241, 244, a rim 243 located in the region of the end 242, a first central through bore 245 extending from the end 241 to a point short of the opposite end 244 and a second bore 246 having a diameter less than the diameter of the bore 245 and extending between the end of bore 245 and the end 244 of the threaded member 242. Threaded member 242 also includes exterior threads 246. End 244 is fitted into hole 239 of washer 236 with rim 243 abutted against the surface 237. Rim 243 is laser welded to the surface 237 of washer 236 by a weld 247. The threads are used to attach the pressure sensor housing to a pressure vessel (not shown). Substrate 250 is extended and sealed into bore 246 and is secured therein in a relationship wherein the center is affixed in bore 246 and the ends protrude out of bore 246

Housing member 226 is generally cylindrical in shape, defines a hexagonally-shaped exterior surface and a hollow interior, and further includes a peripheral circumferentially extending lip or flange 227 at one end which protrudes generally perpendicularly outwardly from the end of the housing member 226. The lip or flange 227 is adapted to be welded to the surface 238 of washer 236 by a weld 228.

A bore 620 is located in and defined in the end 244 of threaded portion 242. Bore 620 has an opening 622 at end 244 and extends toward end 241 in an off-center relationship generally parallel to bore 246. A bead type thermistor 602 has a pair of lead wires 604 and 606. Thermistor 602 is commercially available as part number NDK502C2AR1 from General Electric Thermonetics Corporation.

Thermistor 602 is mounted into bore 620 and is encapsulated with a thermal epoxy 610. Thermal epoxy 610 assists in transferring thermal energy from portion 242 to the thermistor 602.

Lead wires 604 and 606 are attached to electronic circuitry that is mounted on printed circuit board 140. Printed circuit board 140 serves as a power source for thermistor 602. The electronic circuitry is adapted to filter and amplify an electrical signal coming from thermistor 602. The electrical signal from thermistor 602 changes voltage as a function of the temperature that it is subjected to. Board 140 is fitted in the interior of housing 226 in a relationship wherein the peripheral circumferential edge of board 140 is friction fitted against the interior surface of housing member 226 in a generally normal relationship thereto; board 140 is spaced from and generally parallel to the washer 236 and the end 242 of threaded member 242; and the distal end of substrate 250 extends through a central through aperture defined in board 140.

Discussion

One of ordinary skill in the art of designing and using pressure sensors will realize many advantages from using the present invention. The elimination of the diaphragm of prior art sensors eliminates one of the major sources of sensor error and failure and also results in a lower cost assembly.

The present invention is well suited for use as a temperature and pressure sensor for diesel direct fuel injection engines. In a diesel direct fuel injection application, the sensor is affixed into the high pressure common rail that feeds the fuel injectors. In this location, the sensor provides accurate feedback to the control computer of the diesel fuel pressure and temperature just before it enters the engine.

An additional advantage of the present invention is improved accuracy. Since the thermistor and pressure sensitive resistors are in direct contact with the pressure vessel, the sensor can react directly to changes in pressure. Sensors of the prior art have a diaphragm located between the sensor and the pressure vessel. The diaphragm reduces response time and accuracy of the sensor.

Another advantage of the present invention is that the pressure sensor can be assembled at low cost.

Another advantage of the present invention is that the use of the braze alloy or glass results in a hermetic seal that is highly reliable.

While the invention has been taught with specific reference to these embodiments, someone skilled in the art will recognize that changes can be made in form and detail without departing from the spirit and the scope of the invention. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A pressure and temperature sensor for attachment to a pressure vessel comprising:
a) a housing having a high pressure side, a low pressure side and an aperture extending therethrough;
b) a substrate located in the aperture, the substrate having a first end, a second end and a center portion, the center portion being affixed to the housing, and sealing the high pressure side from the low pressure side;
c) at least one pressure sensitive resistor mounted on the first end;
d) at least one reference resistor mounted on the second end;
e) at least one thermistor mounted on the first end;
f) a first circuit line located on the substrate, the first circuit line connected between the pressure sensitive resistor and the reference resistor; and
g) a second circuit line located on the substrate and connected to the thermistor.

2. The sensor according to claim 1, wherein a threaded portion is connected to the high pressure side of the housing.

3. The sensor according to claim 1, wherein the second end of the substrate is connected to a printed circuit board.

4. The sensor according to claim 1, wherein the thermistor is located between a third circuit line and the second circuit line.

5. The sensor according to claim 1, wherein the center portion of the substrate has a metallized area that is brazed in the aperture.

6. A temperature and pressure sensor for sensing a temperature level and pressure level of a pressurized medium, comprising:
a) a housing having a high pressure side, a low pressure side and defining an aperture extending therethrough;
b) a substrate affixed into the aperture, the substrate sealing the high pressure side from the low pressure side;
c) a first and second resistor mounted to the substrate on the high pressure side, the first and second resistors being exposed to the pressurized medium;
d) a third and fourth resistor mounted to the substrate on the low pressure side;
e) a first and second circuit line mounted to the substrate, the first and second circuit lines connecting the resistors into a wheatstone bridge;
f) a bore defined in the housing, the bore defining an opening on the low pressure side and an end located toward the high pressure side; and
g) a thermistor mounted at the end of the bore, the thermistor adapted to be exposed to temperature changes in the pressurized medium.

7. The sensor according to claim 6, wherein the ceramic substrate has a metallized center portion which is brazed to the housing.

8. The sensor according to claim 6, wherein the ceramic substrate is mounted to an insert, the insert being welded to the housing.

9. The sensor according to claim 6, wherein the substrate is mounted to a glass pre-form that is mounted in the aperture.

10. The sensor according to claim 6, wherein the first and second circuit lines and the thermistor are connected to a printed circuit board.

11. The sensor according to claim 10, wherein an electronic circuit is mounted to the printed circuit board.

12. The sensor according to claim 6, wherein the thermistor is sealed into the bore.

13. The sensor according to claim 6, wherein the high pressure side of the housing is threaded.

14. The sensor according to claim 6, wherein the sensor is attached to a common rail of a fuel injection system.

15. A pressure and temperature sensor for use with a pressurized medium comprising:
a) a housing having a first end and a second end, the second end adapted to be exposed to the pressurized medium;
b) an aperture defined in the housing and extending between the first and second ends;
c) a bore defined in the housing and extending from the first end toward the second end;
d) an elongated substrate located in the aperture, the substrate forming a hermetic seal between the first and second ends, the substrate having a first end and a second end;
e) a pressure sensitive resistor mounted to the first end of the substrate, the pressure sensitive resistor being adapted to change resistance in response to a pressure change in the pressurized medium;
f) a reference resistor mounted to the second end of the substrate; and
g) a thermistor mounted in the bore, the thermistor being adapted to change resistance in response to a temperature change in the pressurized medium.

16. The pressure sensor according to claim 15, wherein an electronic circuit is mounted in the housing.

17. The sensor according to claim 16, wherein the thermistor and the resistors are connected to the electronic circuit.

18. The sensor according to claim 15, wherein the substrate has a center portion covered with a metal.

19. The sensor according to claim 18, wherein the center portion is brazed into the housing.

20. A pressure and temperature sensor comprising:
a housing having a cavity and an aperture extending therethrough;
a glass pre-form mounted in the cavity, the glass pre-form having a bore;
a substrate mounted in the bore;
at least one pressure sensitive resistor mounted on the substrate, the pressure sensitive resistor adapted to change resistance in response to a change in pressure; and
at least one thermistor mounted on the substrate, the thermistor adapted to change resistance in response to a change in temperature.

21. The sensor according to claim 20, wherein the substrate has a first end, a second end and a center section.

22. The sensor according to claim 20, wherein the pressure sensitive resistor is mounted to the first end.

23. The sensor according to claim 20, wherein a reference resistor is mounted to the second end.

24. The sensor according to claim 20, wherein the thermistor is mounted to the first end.
